(19) United States
(12) Patent Application Publication
(10) Pub. No.: US 2019/0255877 A1
(43) Pub. Date: Aug. 22, 2019

(54) SUBSTRATES WITH PATTERNED SURFACES

(71) Applicant: HEWLETT-PACKARD DEVELOPMENT COMPANY L.P., HOUSTON, TX (US)

(72) Inventors: YA-TING YEH, TAIPEI CITY (TW); WEN-TA LAI, TAIPEI CITY (TW); KUAN-TING WU, TAIPEI CITY (TW)

(21) Appl. No.: 16/325,478

(22) PCT Filed: Oct. 26, 2016
(86) PCT No.: PCT/US2016/058849

§ 371 Date: Feb. 14, 2019

(51) Int. Cl. B44C 1/22; C23C 8/10; B05D 1/02; B23K 26/362

(52) U.S. Cl. CPC B44C 1/227; C23C 8/10; B23K 26/362; B44C 1/228; B05D 1/02

(57) ABSTRACT

The present subject matter relates to patterned substrates. In an example implementation of the present subject matter, techniques for creating patterns on different substrates are described. In an example, a method of creating the patterns includes spray depositing a plurality of coating layers over the substrate to form a coated substrate, where the plurality of coating layers include at least a top layer, and at least one of a base coating layer, a primer coating layer, and a powder coating layer. The method further includes forming a predefined pattern on the coated substrate by one of laser etching and Computer Numeric Control (CNC) process.

### BACKGROUND

Devices, such as stylus, laptops and mobile phones include an exterior body made of different substrates, such as metals, fibers, and composite materials. Some devices include a housing made from such substrates into which different components of the device are housed. For the devices to be durable and appealing to the users, the substrate should be able to withstand wear and tear due to regular use. At the same time, the substrate of such devices are also fabricated for providing different designs, such as logos and patterns. The designs may either be utilized for providing aesthetic appeal, or may be utilized to distinguish the devices of one manufacturer from that of another.

### BRIEF DESCRIPTION OF DRAWINGS

The following detailed description references the drawings, wherein:

FIG. 1(a) illustrates a device, according to an example implementation of the present subject matter;

FIG. 1(b) illustrates a housing for a device, according to an example implementation of the present subject matter;

FIG. 2 illustrates different stages of fabrication of a housing for a device, according to an example implementation of the present subject matter;

FIG. 3 illustrates different stages of fabrication of a housing for a device, according to an example implementation of the present subject matter;

FIG. 4 illustrates a method of fabricating a housing for a device, according to an example implementation of the present subject matter, and

FIG. 5 illustrates a method of fabricating a housing for a device, according to an example implementation of the present subject matter.

### DETAILED DESCRIPTION

Generally, devices are made of metal or non-metal substrates. The substrates may either form the device, or may form a housing of the device which may house multiple components of the device. To provide strength and appealing appearance to the devices, durable substrates are utilized. However, to keep the devices light and portable, substrates made from metals including aluminum and magnesium, and carbon fibers, or composite materials are generally utilized. While such substrates are light, directly providing any texture or surface designs on these substrates is difficult due to their poor color stability, hardness and chemical resistance.

According to an aspect of the present subject matter, techniques for creating different patterns and logos on substrates are described. These techniques allow formation of patterned features along with distinct finish on the surfaces and sidewalls of the substrates. The substrates may either be directly utilized for manufacturing of the devices, such as stylus, or may also be utilized for the fabrication of the housings for different devices, such as laptops and mobile phones.

In an example implementation of the present subject matter, a metal, or an alloy of the metal, such as aluminum and magnesium, is utilized as a substrate. In another example, the substrate may be made of carbon fibers and composite materials.

If the substrate is a metal, it is treated with micro-arc oxidation (MAO) to form a micro-arc oxide layer on the metal surface. In an example implementation of the present subject matter, the micro-arc oxidized metal may be deposited with multiple coating layers through spray deposition process. The multiple coating layers may include at least a top layer deposited over at least one of a base coating layer, a primer coating layer, and a powder coating layer. Each of the coating layers may be made of different material, such as polymers, and may provide a different functionality, such as heat resistance, hydrophobicity, and anti-bacterial properties.

The substrate, coated with the different layers may then be etched with laser or Computer Numeric Control (CNC) processes to form patterns and designs. The laser etching or the CNC process allow, in an example, formation of a logo on the substrate of the housing, such that the etched portion of the multiple coating layers provides a distinct logo pattern.

In other example, the substrate is either made of carbon fibers, or from composite materials. In such examples, the substrate may directly be deposited with the plurality of coating layers.

The deposition of the multiple coating layers over substrates allows formation of patters on the multiple coating layers through laser etching or CNC processes. This allows for efficient formation of differently patterned features along with distinct finish on the sidewalls and surfaces of the housings.

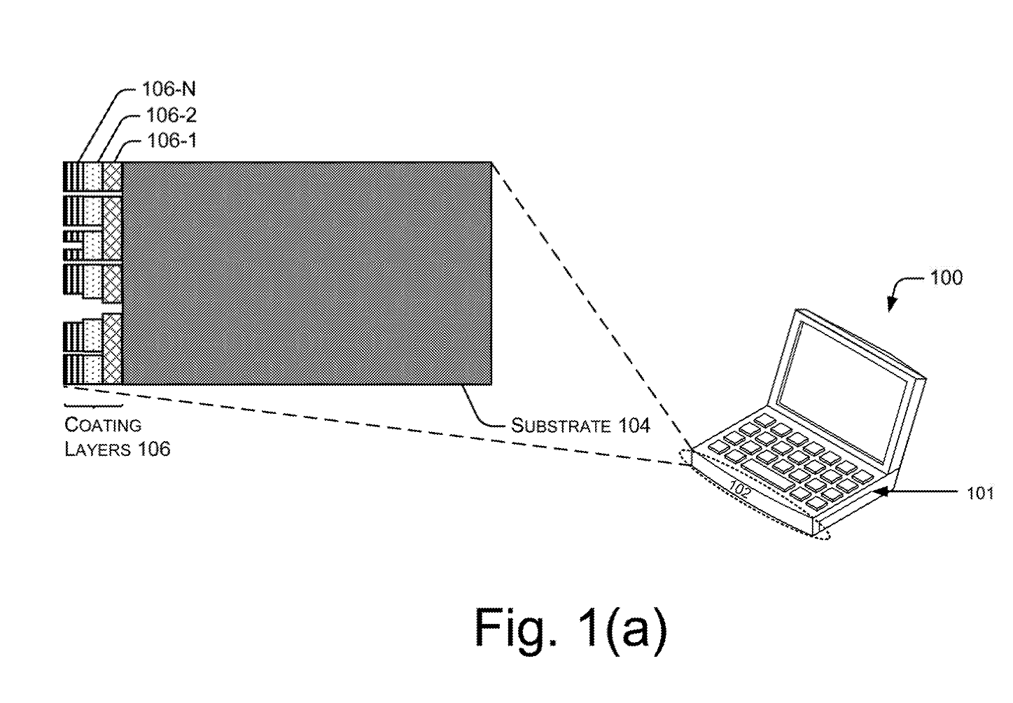

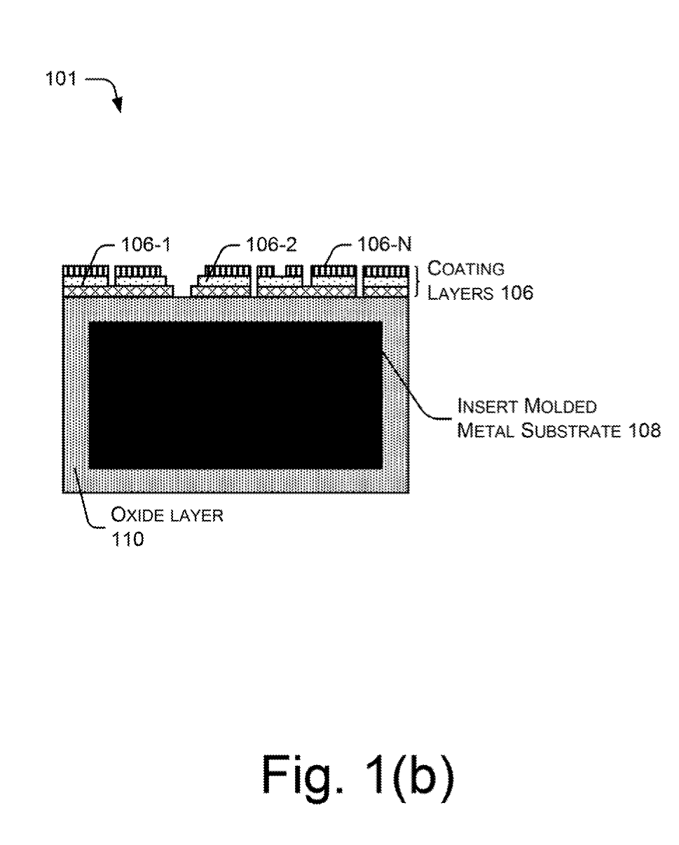

The above techniques are further described with reference to FIGS. 1-5. It should be noted that the description and the figures merely illustrate the principles of the present subject matter along with examples described herein, and should not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1(a) illustrates a device 100, according to an example implementation of the present subject matter. The device 100 may include a housing 101 which may include a sidewall 102. The sidewall 102 of the housing 101 may include a substrate 104 coated with multiple coating layers 106-1, 106-2, . . . 106-N. For the ease of explanation, the coating layers 106-1, 106-2, . . . 106-N have been commonly referred to as coating layers 106. In an example implementation of the present subject matter, the coating layer 106 may include at least two coating layers, such as a base coating layer deposited over the primer coating layer, and then the top coating layer deposited over the combination of the base coating layer and the primer coating layer.

The substrate 102 may either be a non-metal substrate, or may be an insert molded metal substrate. In case the substrate 102 is a non-metal substrate, the multiple coating layers 106 may directly be spray deposited over the substrate 102. Further, in an example implementation of the present subject matter, the multiple coating layers 106 may be etched using laser etching or CNC process to form predefined patterns on the sidewall 102.

FIG. 1(b) illustrates the housing 101, according to an example implementation of the present subject matter. The housing 101 may include an insert molded metal substrate 108 which may include an oxide layer 110. The housing may further include the multiple coating layers 106 coated over the oxide layer 110.

In an example implementation, the insert molded metal substrate 108 may be formed by insert molding a metal along with plastic. The metal utilized for the insert molded metal substrate 108 may include one of aluminum, magnesium, lithium, titanium, zinc, and its alloys. In an example implementation, the plastic may be made of one of polybutylene terephthalate (PBT), polyphenylene sulfide (PPS), polyamide (nylon), polyphthalamide (PPA), acrylonitrile butadiene styrene (ABS), polyetheretherketone (PEEK), polycarbonate (PC), and ABS/PC with 15-50% glass fiber filler.

It would be noted that different processes of insert molding may be utilized to obtain the insert molded metal substrate 108. Further, the choice of the metal, along with the plastic, may be made based on design requisite of the device. As described earlier, the insert molded metal substrate 108 may further include the oxide layer 110. In an example, the oxide layer 110 may be formed through micro-arc oxidation (MAO) process. It would be noted that the MAO process may form the oxide layer 110 around the metal of the insert molded metal substrate 108.

In an example implementation of the present subject matter, the multiple coating layers 106 may include at least two coating layers. For example, the oxidized insert molded metal substrate 108 may be deposited with a base coating layer. Further, a top coating layer may also be deposited over the base coating layer. Similarly, in another example, a powder coating layer may be deposited over the oxidized insert molded metal substrate 108, and the top coating layer may then be deposited over the powder coating layer. In another example, a primer coating layer may be deposited over the oxidized insert molded metal substrate 108, and the top coating layer may then be deposited over the primer coating layer the top coating layer may be deposited over a powder coating layer.

In another example, two or more coating layers may be deposited onto the oxidized insert molded metal substrate 108, and the top coating layer may then be deposited over the two or more coating layers. For example, a base coating layer deposited over the primer coating layer, and then the top coating layer deposited over the combination of the base coating layer and the primer coating layer.

Similarly, in another example, the powder coating layer may be deposited over the base coating layer, and the top coating layer may then be deposited over the combination of the powder coating layer and the base coating layer. Therefore, it would be noted that the multiple coating layers 106 may include different combination of the top coating layer, the powder coating layer, the primer coating layer, and the base coating layer.

In an example implementation of the present subject matter, the base coating layer is made of barium sulfate, talc, dyes, and color pigments. Further, the primer coating layer and the powder coating layer is made of one of carbon black, titanium dioxide, clay, mica, talc, barium sulfate, calcium carbonate, synthetic pigments, metallic powders, aluminum oxide, carbon nanotubes (CNT), graphene, and graphite. Furthermore, the top coating layer is made of one of fluorinated olefin-based polymers, specialty fluoroacrylates, fluorosiliconeacrylates, fluorourethanes, perfluoropolyethers, perfluoropolyoxetanes, fluorotelomers, polytetrafluoroethylene (PTFE), polyvinylidenefluouride (PVDF), fluorosiloxane, fluoroUV polymers and hydrophobic polymers.

In another example implementation of the present subject matter, the top coating layer may have hydrophobic, anti-bacterial, anti-smudge, and anti-fingerprint properties. The utilization of the various coating layers within the multiple coating layers 106 may provide the housing 100 of the device with multiple defined functionalities. For example, the use of the anti-smudging top coating layer may allow the surface of the housing 100 to be smudge free. Similarly, the use of base coating layer may allow different coating layers to deposit easily over the oxide layer 110 and may improve adhesion between different coating layers within the multiple coating layers 106.

In an example implementation of the present subject matter, the multiple coating layers 106 may be etched to remove portions of the coating layers 106. Such etching may form predefined pattern over the surface of the housing 100. In an example, the etching may be done by either a laser etching process, or a Computer Numeric Control (CNC) process. The use of the etching process may allow formation of different patterns over the multiple coating layers 106, which may provide a different texture and finish to the housing 100.

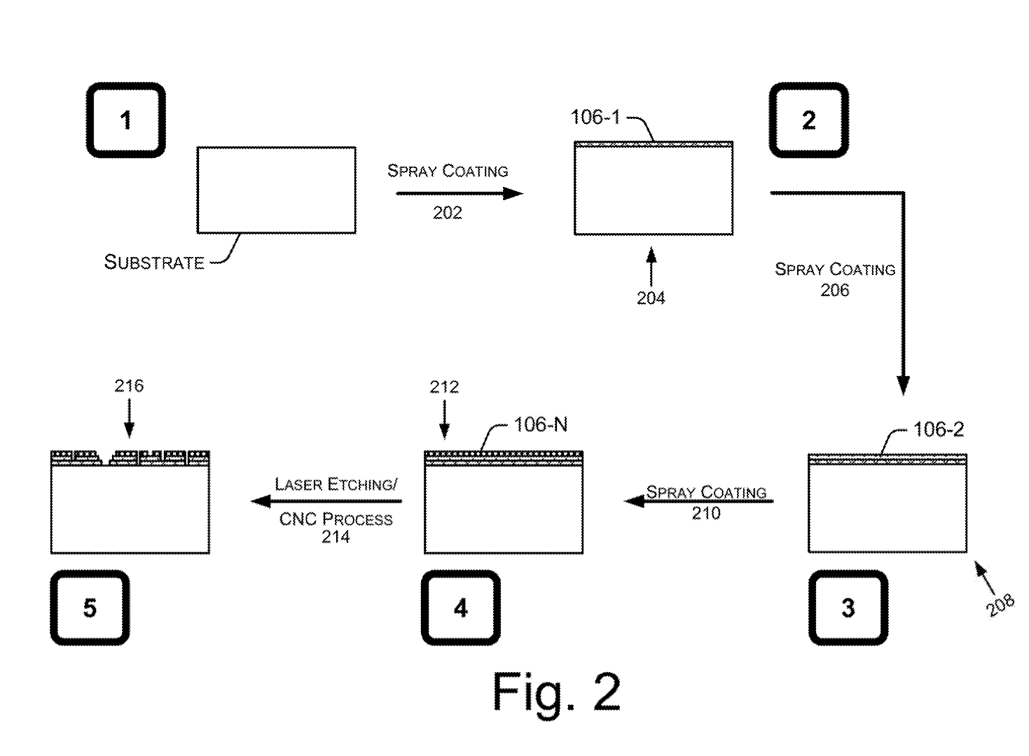

These and other aspects are further described in conjunction with the various different stages of fabrication of a housing for a device which are illustrated in FIGS. 2-5.

FIG. 2 illustrates different stages of fabrication of a housing for a device, according to an example implementation of the present subject matter. The different stages of fabrication of the housing are marked from stage 1 to stage 5. At stage 1, a substrate for the purpose of fabrication of the housing is chosen. The substrate may be chosen based on the requisite of the housing. For example, to provide high strength to the housing, carbon fiber may be chosen as the substrate. Alternatively, to provide light and cost effective housings, plastic and composite materials may also be utilized. Further, to provide high strength with metallic exterior looks, metals, such as aluminum, magnesium, zinc and its alloys may be chosen. Therefore, depending on the requisite of the housings, a corresponding substrate may be chosen.

The chosen substrate may be subjected to spray coating 202 to deposit a coating layer over the substrate. For example, the coating layer 106-1 may be deposited over the substrate. As described earlier, the coating layer 106-1 may include either a base coating layer, a primer coating layer, or a powder coating layer. Each coating layer may provide a defined functionality to the substrate. For example, the base coating layer may act as an adhesive between the substrate and the top coating layer. For the ease of reference, the substrate coated with a single coating layer, such as the coating layer 106-1, may be referred to as a single coating layer coated substrate 204, hereinafter.

In an example implementation of the present subject matter, the spray coating 202 may be done for a time period of about 20 to 40 minutes, and at a temperature range of about 50° C. to 140° C. For example, the spray coating 202 may deposit the base coating layer over the substrate for about 35 minutes within a temperature range of about 50° C. to 80° C. In another example, the spray coating 202 may deposit a primer coating layer onto the substrate for about 40 minutes at about 80° C. In an example, the coating layer deposited through the spray coating 202 may have a thickness of about 20 to 60 micro meter (μm)

The single coating layer coated substrate 204 at stage 2 may be further coated with one or more spray coatings, 206 and 210, at stage 3 and at stage 4, respectively, to form one or more coating layers 106-2, 106-N, over the single coating layer coated substrate 204. The substrate with two coating layers, at stage 3, is referred to as a double coating layer coated substrate 208. Further, the substrate with multiple coating layers at stage 4 is referred to as multiple coating layers coated substrate 212.

In an example implementation of the present subject matter, the spray coating 204 may deposit one of the base coating layer, primer coating layer, and the powder coating layer. In an example, the second coating layer deposited over the substrate may be different from the first coating layer deposited after spray coating 202. That is, if a primer coating layer is deposited through the spray coating 202, a base coating layer may be deposited through the spray coating 206. Similarly, if a powder coating layer is deposited through the spray coating 202, a primer coating layer may be deposited through the spray coating 206. Therefore, in an example, the spray coating 206 may deposit a different coating layer onto the substrate, from what has been deposited through the spray coating 202.

Alternatively, in another example implementation, the spray coating 206 may deposit a coating layer similar to the coating layer deposited through the spray coating 202. For example, if a powder coating layer is deposited through the spray coating 202 onto the substrate, another powder coating layer may be deposited onto the substrate through the spray coating 206. The spray coating of a similar coating layer after stage 2 may be done to increase the thickness of the coating layer deposited after stage 1. This may be done to either increase the thickness of the coating layer, or to remove any defect in the spray coating 202.

The substrate at stage 3 may further be spray coated through the spray coating 210. The top coating layer may be deposited at stage 4, through the spray coating 2010. As described earlier, the top coating layer may be made of one of fluorinated olefin-based polymers, specialty fluoroacrylates, fluorosiliconeacrylates, fluorourethanes, perfluoropolyethers, perfluoropolyoxetanes, fluorotelomers (C-6 or lower products), polytetrafluoroethylene (PTFE), polyvinylidenefluouride (PVDF), fluorosiloxane, fluoroUV polymers and hydrophobic polymers (C-7 or longer). Further, the top coating layer may also include hydrophobic, anti-bacterial, anti-smudge, and/or anti-fingerprint properties.

It would be noted that while two stages of further spray deposition of coating layers are described after the spray coating 202, either a single stage of spray coating or three or more stages of spray coating may also be utilized, depending on the requisite of coating layer deposition for the housing and formation of the predefined patterns. For example, after the spray coating 202, a single spray coating may be utilized to deposit the top coating layer. In another example, after spray coating 202, three stages of spray coating may be utilized such that the top coating layer is deposited over three coating layers.

Hence, based on the spray coating process, multiple coating layers 106 may be deposited over the substrate. A mix of the base coating layer, the powder coating layer, and the primer coating layer may be deposited over the substrate through the spray coating process.

In an example implementation of the present subject matter, the multiple coating layers 106 coated onto the substrate may be etched to form predefined pattern. In an example, one of the laser etching process or the CNC process may be utilized to form the predefined pattern. Depending on the pattern, the laser etching mechanism, or the CNC process, may etch the surface to different depths at different regions. The etching process may either be utilized to form random patterns over the multiple coating layers 106, or may also be utilized to engrave company logos on the surface.

In an example implementation, the etched and multiple coating layer deposited substrate is referred to as substrate 216, and may be utilized to form the sidewalls of the housing, such that the sidewalls of the housing may include different patterns and textures.

The substrate 216 at stage 5 may further be subjected to deposition of a top coating layer, in an example implementation of the present subject matter. That is, upon formation of the predefined patter through the laser etching or the CNC process, the substrate may be spray coated with the top coating layer. The top coating layer may be spray coated at about 80 to 140° C., for about 20 to 40 minutes. The spray coating of the top coating layer after the etching and formation of the predefined pattern may provide protection to the formed pattern from any unwanted abrasions.

As described earlier, the substrate chosen at the stage 1 may also include metals, such as aluminum, magnesium, lithium, titanium, zinc, and a combination thereof. In case the substrate is a metal, it may either be deposited with multiple coating layers 106 through the spray coating stages as described in FIG. 2, or it may first be subjected to a micro-arc oxidation process (MAO), prior to spray coating of any coating layer. The MAO process may be applied to the metal substrate to deposit an oxide layer 110 over the metal surface. The oxide layer 110 may provide protection to the metal from abrasion and corrosion processes, thereby providing durability and longevity.

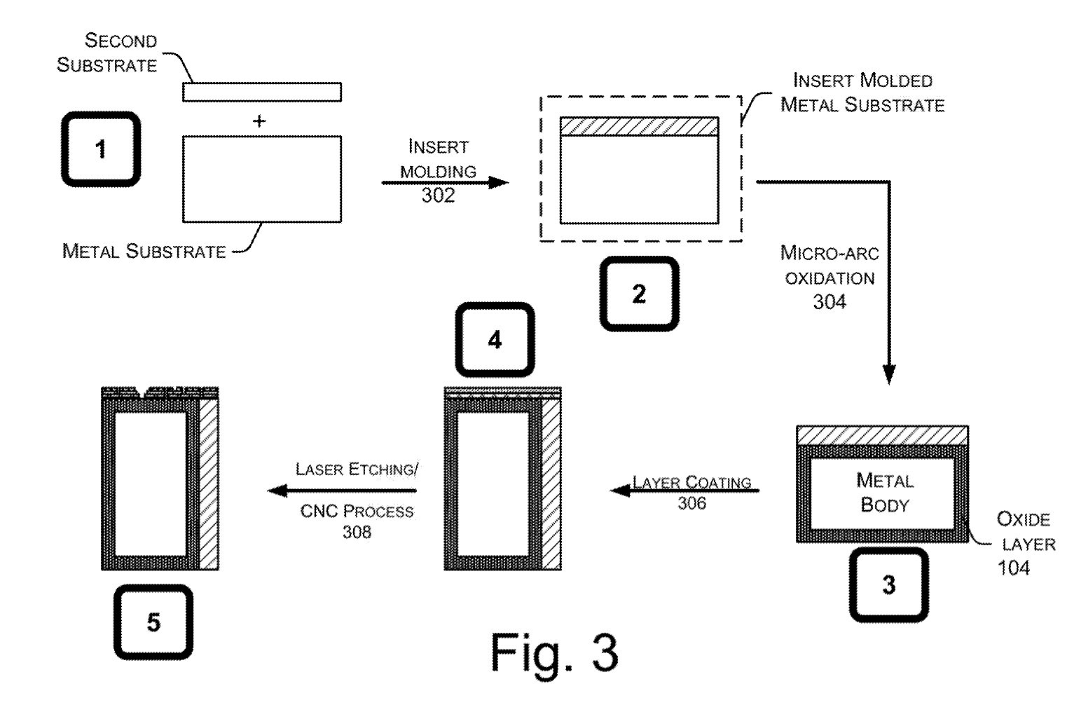

For the ease of explanation, FIG. 3 describes various stages of fabrication of the housing, when the substrate is a metal. Referring to FIG. 3, at stage 1, a second substrate may be chosen to be molded along with the metal substrate. The choice of the second substrate may be based on the requisite of the housing. For example, to provide high strength, the second substrate may be chosen to be carbon fibers. However, to provide light and cost effective housing, plastic may be chosen as the second substrate. In an example, the second substrate may include one of polybutylene terephthalate (PBT), polyphenylene sulfide (PPS), polyamide (nylon), polyphthalamide (PPA), acrylonitrile butadiene styrene (ABS), polyetheretherketone (PEEK), polycarbonate (PC), and ABS/PC with 15-50% glass fiber filler.

In an example implementation of the present subject matter, the metal substrate and the second substrate may be subjected to insert molding 302 to form an insert molded metal substrate.

The insert molded metal substrate may be further subjected to a micro-arc oxidation process 304 to form an oxide layer 110 over the metal substrate. In an implementation, the insert molded metal substrate may also be processed through polishing, degreasing, activating, and neutralizing processes, prior to the micro-arc oxidation process 304.

The surfaces of the insert molded metal substrate may be polished using polishing agents, such as abrasives to remove surface irregularities, such as burrs on the surfaces of the metal substrate. In an example implementation, the surfaces of the insert molded metal substrate may be polished through one of electro-polishing, mechanical polishing, and buffing.

Upon polishing, the surfaces of the insert molded metal substrate may be degreased to remove impurities, such as fat, grease, and oil. In an example implementation, the surfaces of the insert molded metal substrate may be degreased through ultrasonic degreasing by using alkaline cleaners. The surfaces of the insert molded metal substrate may also be degreased by passing hot water over the insert-molded component.

Upon degreasing, the surfaces of insert molded metal substrate may be activated to remove any layer of natural oxides that may have formed on the metal substrate of the insert molded metal substrate, due to exposure to the atmosphere. In an example implementation, the surfaces of metal substrate may be activated through acid activation. Acids, such as nitric acid, acetic acid, and sulfuric acid may be used for acid activation. Acid activation also removes alkaline solutions that may get stuck to the metal substrate while the insert molded metal substrate is degreased using alkaline cleaners.

Upon activation, the surfaces of the insert molded metal substrate may be neutralized. In an example implementation, the surfaces of the insert molded metal substrate may be neutralized through alkaline neutralization using weak alkaline solutions, such as alkaline solutions of one of sodium carbonate, sodium hydroxide, ammonia and sodium hexametaphosphate.

Once the insert molded metal substrate is processed and ready for micro-arc oxidation process 304, the insert molded metal substrate may be oxidized through the MAO process to form an oxide layer 110 on the metal substrate of the insert molded metal substrate. In an example implementation, MAO includes electrolysis of an electrolyte solution with the insert molded metal substrate immersed in the electrolyte solution. The electrolyte solution may be an alkaline solution of one of sodium silicate, metal phosphate, potassium fluoride, potassium hydroxide or sodium hydroxide, fluorozirconate, sodium hexametaphosphate, sodium fluoride, ferric ammonium oxalate, phosphoric acid salt, graphite powder, silicon dioxide powder, aluminum oxide powder, metal powder, and polyethylene oxide alkylphenolic ether. In an example implementation, the electrolyte solution may include a concentration in a range of about 0.05% by volume to about 15% by volume and has a pH in a range of about 8 to about 13.

In an example implementation, the electrolyte solution may be kept inside an electrolytic bath and maintained at a temperature in a range of about 10° C. to about 45° C. The insert molded metal substrate is immersed in the electrolyte solution inside the electrolytic bath. The insert molded metal substrate acts as an electrode during electrolysis of the electrolyte solution. For electrolysis, an electrical signal at a voltage in a range of about 150 volts to about 550 volts may be periodically passed through the electrolyte solution. In an example implementation, periodically passing the electrical signal includes passing the electrical signal through the electrolyte solution for a time duration in a range of about 2 minutes to about 3 minutes and then cutting off the electrical signal for a time duration in a range of about 5 seconds to about 20 seconds. This process of passing the electrical signal through the electrolyte solution and cutting off the electrical signal may be repeatedly performed for a definite time period of, for example, 20 minutes. At the end of the electrolysis, the oxide layer 110 may be formed on the metal substrate of the insert molded metal substrate.

The thickness of the oxide layer 110 may depend on the definite time period for which the electrolysis is performed. In an example implementation, the oxide layer 110 has a thickness in a range of about 3 μm to about 15 μm. The oxide layer 110 may be formed of a metal oxide, or a combination of metal oxides. For example, when the metal substrate is made of aluminum, the oxide layer 110 is formed of aluminum oxide (Al₂O₃). In another example, when the metal substrate is made of an alloy of magnesium, aluminum, and zinc, then the oxide layer 110 is formed of a combination of magnesium oxide, aluminum oxide, and zinc oxide.

In an example implementation of the present subject matter, the MAO based insert molded metal substrate may be heated at a temperature in a range of 60° C. to 80° C. for a time duration in a range of 10 minutes to 30 minutes, to dry the oxide layer 110. After the oxide layer 110 is formed on the metal substrate, the MAO based insert molded metal substrate may be formed at stage 3.

The MAO based insert molded metal substrate may be subjected to layer coating process 306 to deposit multiple coating layers 106. The layer coating process 306 may include multiple spray coating processes to deposit one or more coating layers onto the MAO based insert molded metal substrate.

In an example implementation of the present subject matter, the layer coating process 306 may spray coat more than one of the top coating layer, the powder coating layer, the primer coating layer, and the base coating layer. The spray coating may be done at 80° C. to 160° C., for about 20 to 40 minutes. For example, the layer coating process 306 may spray coat three different coating layers, such as the base coating layer, the primer coating layer, and the top coating layer onto the MAO based insert molded metal substrate. In another example, the layer coating process 306 may coat 2 different coating layers, such as the base coating layer and the top coating layer onto the MAO based insert molded metal substrate. Therefore, it would be noted that the MAO based insert molded metal substrate may be coated with multiple coating layers 106 through the layer coating process 306.

In another example implementation of the present subject matter, the MAO based insert molded metal substrate, coated with multiple coating layers 106 at stage 4, may be subjected to one of the laser etching and CNC process to form predefined pattern on the multiple coating layers 106. In an example implementation, the etched and multiple coating layer deposited MAO based insert molded metal substrate may be utilized to form the sidewalls of the housing, such that the sidewalls of the housing may include different patterns and textures. Depending on the requisite pattern, the laser etching mechanism, or the CNC process, may etch the surface to different depths at different regions. The etching process may either be utilized to form random patterns over the multiple coating layers 106, or may also be utilized to engrave company logos on the surface.

The etched and multiple coating layer deposited substrate at stage 5 may further be subjected to deposition of a top coating layer, in an example implementation of the present subject matter. That is, upon formation of the predefined pattern through the laser etching or the CNC process, the substrate may be spray coated with the top coating layer. The top coating layer may be spray coating at about 80 to 140° C., for about 20 to 40 minutes. The spray coating of the top coating layer after the etching and formation of the predefined pattern may provide protection to the formed pattern from any unwanted abrasions.

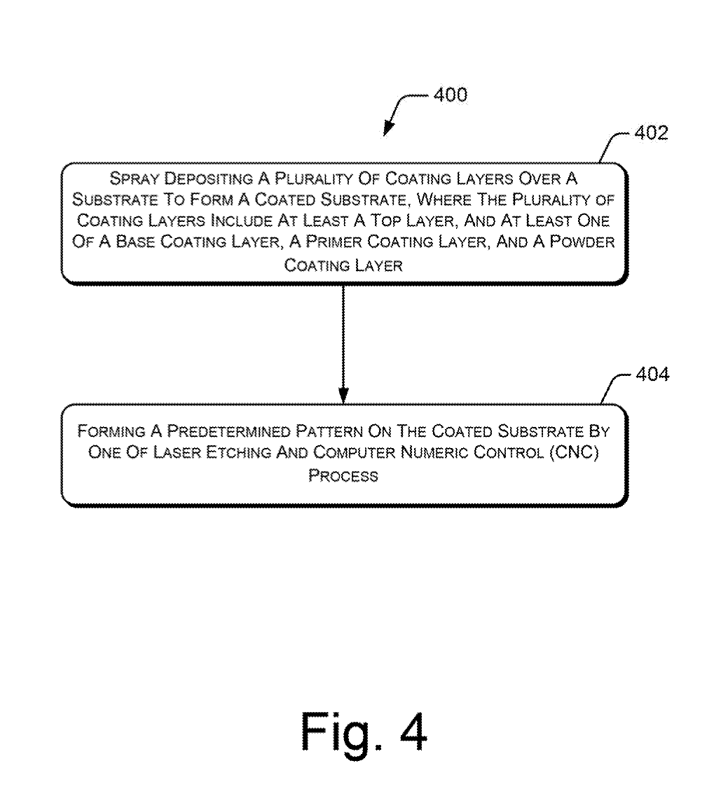

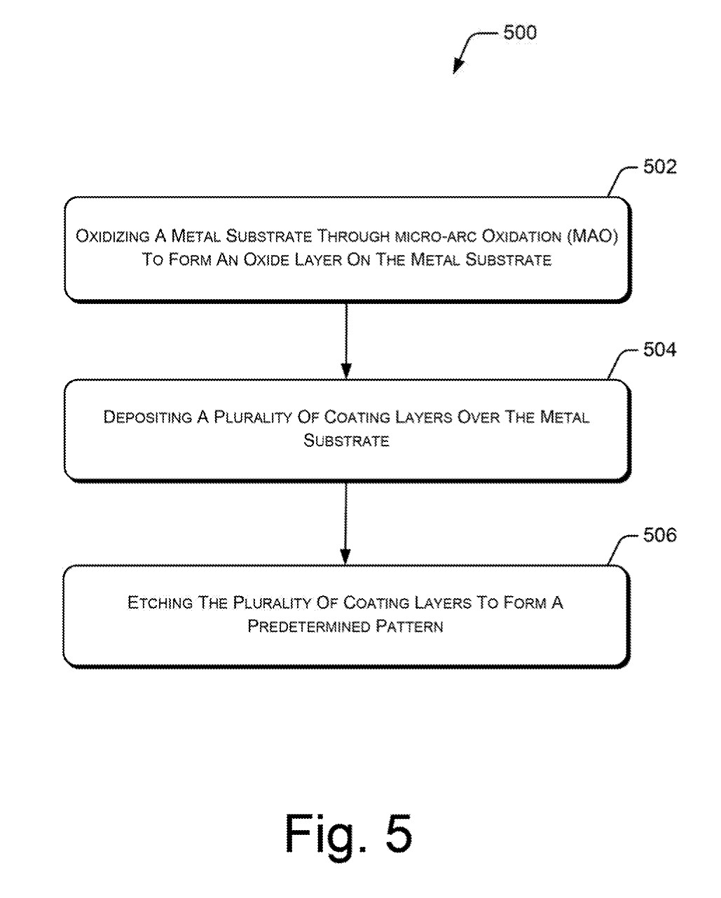

FIG. 4 and FIG. 5 illustrate methods 400 and 500 of manufacturing a patterned substrate, according to an example implementation of the present subject matter. While the method 500 is described in context of fabrication of the housing 100 for devices, the method may be utilized for fabrication of other components as well.

Referring to FIG. 4, at block 402, a plurality of coating layers is spray deposited over a substrate to form a coated substrate, where the plurality of coating layers includes at least a top layer, and at least one of a base coating layer, a primer coating layer, and a powder coating layer. It would be noted that each coating layer from amongst the plurality of coating layers provide a defined functionality. In an example implementation of the present subject matter, the substrate may either be a metal, a light metal, carbon fiber, plastic, or composite material. Depending on the requisite of use, the substrate may be chosen.

Further, in an example implementation of the present subject matter, the plurality of coating layers may include two or more of the top coating layer, the powder coating layer, the primer coating layer, and the base coating layer. For example, base coating layer may be deposited over primer coating layer and powder coating layer to form three coating layers. Further, the three coating layers may be further deposited with the top coating layer.

In another example, one coating layer may be deposited more than once onto the substrate. For instance, base coating layer may be utilized as the first coating layer, and the powder coating layer may be deposited over the base coating layer as the second coating layer. In such example, the base coating layer may again be deposited over the second powder coating layer. The three coating layers may then be finally coated with the top coating layer. Therefore, it would be noted that multiple coating layer may be spray deposited onto the substrate.

In an example implementation of the present subject matter, each coating layer may provide a defined functionality. For example, the top coating layer may provide heat resistance, hydrophobicity, and anti-bacterial properties.

At block 404, a predefined pattern is formed on the coated substrate by one of laser etching and CNC process. In an example, the etched coated substrate may be utilized to form the sidewalls of the housing, such that the sidewalls of the housing may include different patterns and textures. Depending on the requisite pattern, the laser etching mechanism, or the CNC process may etch the coated substrate to different depths at different regions. The etching process may either be utilized to form random patterns over the plurality of coating layers, or may also be utilized to engrave company logos on the surface.

In an example implementation of the present subject matter, the etched plurality of coating layers may further be subjected to deposition of a top coating layer, to protect the housing from unwanted abrasions.

Referring to FIG. 5, at block 502, a metal substrate is oxidized through MAO, to form an oxide layer on the metal substrate. In an example implementation of the present subject matter, the metal substrate is insert molded along with a secondary substrate, such as plastic and carbon fiber.

At block 504, a plurality of coating layers is deposited over the metal substrate. In an example implementation of the present subject matter, the deposition of the plurality of coating layers is done through spray coating process. It would be noted that the plurality of coating layers may include different combinations of the top coating layer, the powder coating layer, the primer coating layer, and the base coating layer.

At block 506, the plurality of coating layers is etched to form a predefined pattern. In an example implementation of the present subject matter, the etching is done by one of a laser etching process and a CNC process. Further, in another example, the etched plurality of coating layers may further be coated with the top coating layer to prevent the housing from the corrosion for metal substrates.

Although examples for the present disclosure have been described in language specific to structural features and/or methods, it should be understood that the appended claims are not necessarily limited to the specific features or methods described. Rather, the specific features and methods are disclosed and explained as examples of the present disclosure.

We claim:

1. A method for creating patterns on a substrate, the method comprising:
spray depositing a plurality of coating layers over the substrate to form a coated substrate, wherein the plurality of coating layers include at least a top coating layer and one of a base coating layer, a primer coating layer, and a powder coating layer; and
forming a predefined pattern on the coated substrate by one of laser etching and Computer Numeric Control (CNC) process.

2. The method as claimed in claim 1, for the substrate being of a material which is a metal, prior to the spray depositing, oxidizing the metal through micro-arc oxidation (MAO) process to form an oxide layer on the metal, wherein the plurality of coating layers is deposited over the oxide layer.

3. The method as claimed in claim 1, wherein the top coating layer is deposited on top of at least two of the base coating layer, the primer coating layer, and the powder coating layer.

4. The method as claimed in claim 1, wherein the spray depositing for each of the plurality of coating layers is performed for a time period of about 20 to 40 minutes, at a temperature range of about 80° C. to 140° C.

5. The method as claimed in claim 1, wherein the method further comprises spray depositing another top coating layer over the predefined pattern.

6. The method as claimed in claim 1, wherein the substrate is made of one of carbon fibers, plastic, and composite material.

7. A housing of a device comprising:
a metal substrate with an oxide layer, wherein the metal substrate is insert molded with a second substrate of the housing;
a plurality of coating layers deposited over the metal substrate with the oxide layer, wherein the plurality of coating layers include at least a top coating layer and one of a base coating layer, a primer coating layer, and a powder coating layer, and wherein the plurality of coating layers is etched to form a predefined pattern by one of laser etching and Computer Numeric Control (CNC) process.

8. The housing as claimed in claim 7, wherein the oxide layer is formed by a micro-arc oxidation (MAO) process.

9. The housing as claimed in claim 7, wherein the metal substrate is made of one of aluminum, magnesium, lithium, titanium, zinc, and a combination thereof, and wherein the second substrate is made of plastic.

10. The housing as claimed in claim 7, wherein the top coating layer is deposited on top of at least two of the base coating layer, the primer coating layer, and the powder coating layer.

11. The housing as claimed in claim 7, wherein the top coating layer is at least one of a hydrophobic, an anti-bacterial, an anti-smudge, and an anti-fingerprint coating layer.

12. The housing as claimed in claim 7, wherein the top coating layer is made of one of fluorinated olefin-based polymers, specialty fluoroacrylates, fluorosiliconeacrylates, fluorourethanes, perfluoropolyethers, perfluoropolyoxetanes, fluorotelomers, polytetrafluoroethylene (PTFE), polyvinylidenefluouride (PVDF), fluorosiloxane, fluoroUV polymers and hydrophobic polymers.

13. The housing as claimed in claim 7, wherein the base coating layer is made of one of barium sulfate, talc, dyes, and color pigments.

14. The housing as claimed in claim 7, wherein the primer coating layer and the powder coating layer are made of one of carbon black, titanium dioxide, clay, mica, talc, barium sulfate, calcium carbonate, synthetic pigments, metallic powders, aluminum oxide, Carbon nanotubes (CNT), graphene, and graphite.

15. A device comprising a housing to house different components of the device, the housing comprising:
a substrate forming a sidewall of the housing; and
a plurality of coating layers deposited over the substrate, wherein the plurality of coating layers include at least a top coating layer and one of a base coating layer, a primer coating layer, and a powder coating layer, and wherein the plurality of coating layers is etched to form a predefined pattern by one of laser etching and Computer Numeric Control (CNC) process.
